(19) United States
(12) Patent Application Publication
(10) Pub. No.: US 2007/0153463 A1
(43) Pub. Date: Jul. 5, 2007

(54) Adjustable receptacle for MP3 player

(76) Inventor: Thomas Choi, Edison, NJ (US)

Correspondence Address: OSTROLENK FABER GERB & SOFFEN, 1180 AVENUE OF THE AMERICAS, NEW YORK, NY, 100368403, US

(21) Appl. No.: 11/324,899

(22) Filed: Jan. 4, 2006

(51) Int. Cl. G06F 1/16

(52) U.S. Cl. 361/683; 381/332

(57) ABSTRACT

An audio supply apparatus such as a radio with a receptacle for a MP3 player. The receptacle includes a recess with a cradle therein sized to receive various thickness and shape MP3 players. A slide to the rear of the MP3 player in the cradle, adjustable by a thumb screw or a similar functioning device, for moving a plate in a gap between the rear of the player and the rear wall of the cradle to provide a position support for the rear side of the MP3 player. An electrical connection in the cradle to the supported MP3 player. An optional adapter in the cradle a gap to the front of the MP3 player.

### BACKGROUND OF THE INVENTION

The present invention concerns a support and power supply receptacle adjustable for different size audio content players, and particularly useful for supporting and supplying power to an audio content player of a type commonly known as an MP3 player. A primary example of a MP3 player for which the receptacle may be designed and dimensioned is known by the trademark iPod®, although the invention is not specific to only one brand or one type of MP3 or audio content supply. Hereafter, the audio content supply for which the invention is adapted is referred to as a MP3 player. But, it is understood that any portable audio supply device may be the subject of the present invention, and the receptacle would be adapted to the particular type of audio supply.

A MP3 player includes at least one port to which connections may be made to enable listening to audio content from the player, e.g., connections for earphones, or earplugs or speakers. The MP3 player therefore becomes the source of the sound signal to the earphones, earplugs or speakers.

Speakers in particular or other sound supply devices may be connected to the MP3 player through a support apparatus that supports the MP3 player and is connected to the connection port of the MP3 player. Frequently, that support for the MP3 player is connected with a unit including audio speakers and various audio sound controls (volume, tone, etc.), and possibly controls for the audio content on the MP3 player. For example, a speaker or speakers may be integrated in or attached to a body having a receptacle into which the MP3 player is installed, for both mechanically supporting the player and electrically connecting the player for audio supply by the speakers. The typically portable MP3 player is typically manually placeable in and manually removable from its receptacle.

The support apparatus, including the body in which the MP3 player is removably installable, may be operable for control of and delivery of the audio signal from the MP3 player or may include other apparatus and controls for the MP3 player. In one primary example described herein, the support apparatus may be what is known as clock radio, which includes a clock, a time alarm associated with the clock, an independent source of an audio signal, such as a radio, television or other source of audio as well as a connection to a MP3 player that is received in the receptacle in the body of the apparatus. When the apparatus is used as an alarm clock or an apparatus with a time controlled start and stop, a connection to the MP3 may be turned on to supply audio content and turned off via time controls on the apparatus. The invention is particularly described herein as used for a clock radio. But, its use is not limited to that type of audio supply apparatus.

Audio content supplies, such as MP3 players, are available from several sources, and from each individual source, in various shapes and dimensions. Any of them may be used as the audio content supply for the audio apparatus. A receptacle in the body of the audio apparatus is adapted to receive the MP3 player and particularly to connect to the port or connection to the player, from which an electrical signal which is transduceable into an audio signal is supplied and including connections for controlling operations of the MP3 player. The receptacle also should support the installed MP3 player in a stable manner and at a selected orientation so that the MP3 player is connected to deliver its signal and is mechanically controlled, so that it is stable against shifting in the body of the audio supply apparatus when that apparatus is normally moved and used and so that the MP3 player can be easily installed in and removed from the audio supply apparatus by a user.

To accommodate various types, shapes and sizes of MP3 players, it is conventional to supply shaped adapters for the receptacle in the audio supply apparatus. Each adapter is shaped to define a nest for a specific size, shape and configuration MP3 player which the user may have. A user will want to install an adapter for a specific MP3 player or content supply which the user wishes to install in the receptacle. This may cause suppliers of the audio supply apparatus to also have to supply a variety of different receptacle adapters for use in the audio supply apparatus. This, in turn, requires the production and assembly with the apparatus of extra parts with attendant additional expense, requires some skill of a user to customize his audio supply apparatus for his particular MP3 player, and if the user has more than one type of MP3 player which vary in size and shape, requires replacement of the adapters depending upon which MP3 player is being installed. Extra small size adapter pieces will almost inevitably become lost or misplaced or a user may, through inadvertence, lack of understanding or lack of spatial perception, select the wrong adapter for installation which may cause the audio supply apparatus to fail to function properly, may prevent easy installation and removal of the MP3 player and may compromise adequate support for the MP3 player.

MP3 players are available in various different shapes and sizes. Two of the dimensions are relevant to a receptacle in a support apparatus for a MP3 player, namely their lateral side to lateral side width and their front to back thickness. For example, the MP3 player known by the trademark iPod® is available in at least three different front to back thicknesses and respective different widths as well. It is preferable that the receptacle in the audio supply apparatus be able to receive, position at the connections to the MP3 player and stably support each type of MP3 player in the receptacle, regardless of the width and thickness dimensions of the MP3 player.

### SUMMARY OF THE INVENTION

It is an object of the present invention to provide an audio supply apparatus with a receptacle for content supply, such as a MP3 player, which is adapted to receive, properly support, hold, orient and enable removal of various available size and shape configuration MP3 players.

Another object of the invention is to eliminate or reduce the requirement that various adapters be provided for the receptacle to adapt it for each of the different size and shaped MP3 players.

According to the present invention, the audio supply apparatus, for example a clock radio, includes a receptacle in its body with a receiving opening, preferably on the top surface of the body opening into a recess. Below the top surface, there is a cradle in the recess for the MP3 player located inside the body enclosure of the clock radio. The cradle is located at a depth below the top surface of the radio in the receptacle, so that a MP3 player installed in the recess will have its lower region in the recess and supported on the cradle while a large portion of the player above its lower region, perhaps over two-thirds of its height or more, projects above the top of the receptacle and the body. This provides a large region of the MP3 player which can be grasped for installation and removal and exposes the portion of the MP3 player on which some controls and information concerning content, etc., are located and displayed, so that the user has access to the controls and information of the MP3 player.

A typical MP3 player has a port on its bottom side to receive a connector, typically a 32-pin connector, by which electrical signals for audio from the MP3 player and control signals to the MP3 player and power may be supplied to the MP3 player by appropriate plugs connected to applicable other apparatus. The cradle supports the 32-pin connector of the MP3 player. Therefore, the support for the MP3 player should be configured so that when the MP3 player is installed, the connector on the cradle is received in the port in the MP3 player, regardless of the size and shape of the player.

Rather than providing separate adapters of varying front to rear thickness to be installed into the receptacle and at the cradle for the MP3 player depending upon the front to back thickness and configuration of the MP3 player, according to the invention, the front to back thickness of the receiving region of the receptacle is adjustable by a device in the receptacle in the body of the apparatus wherein the user can simply adjust the size of the receptacle in the front to back direction for accommodating the particular thickness of the MP3 player.

In the preferred embodiment, behind the MP3 player, a slide is installed which is supported on a shelf or surface of the support apparatus to be able to move forwardly and rearwardly in the receptacle to engage and press against one of the surfaces and preferably the rear surface of the MP3 player. A slide control device is built into the apparatus. In the preferred form, the slide control device includes a screw, such as a rotatable thumb screw, which is supported so as not to be shiftable axially. The screw is screw connected with the slide, so that rotation of the screw moves the slide forward or rearward. The user places the MP3 player in the receptacle and on the connector and then adjusts the slide to the appropriate supporting position or adjusts the slide to a selected position for supporting the MP3 player and then installs the player in the receptacle.

For assured support of the player and to enable slight rocking of the player or tipping of the player when it is being installed and removed, a resilient, e.g., rubber, pad may be disposed on the front side of the slide. The rubber pad additionally provides frictional resistance to the player dislodging from the receptacle and assures its connection in the cradle.

Because MP3 players are of various front to back thicknesses and various side to side widths, in the present design, an adapter may still be provided for receiving and cradling the front and lateral sides of the MP3 player to position it in the receptacle. For various size and shape MP3 players, respective various size and shape adapters are provided. For a large thickness MP3 player, there is no space in the cradle between the front wall of the cradle and the player when the pin connector is in the port of the MP3 player positioned on the connector in the cradle. For a MP3 player that is thinner front to rear, there may be a gap between the front wall of the cradle and the front wall of the player when the connector of the cradle is in the port of the MP3 player. An adapter may be inserted in that gap or may be permanently installed at the front side of the cradle to close the gap when the MP3 player is installed in the receptacle and on the connector.

The adapter has a profile generally corresponding to the front and to the lateral sides of the MP3 player and is profiled to position the MP3 player correctly front to rear and laterally in the receptacle, which eases its installation on the 32-pin connector. If the adapter has already been installed, after insertion of the MP3 player, the slide is moved in the manner described above to contact and support the MP3 player.

Other features and advantages of the present invention will become apparent from the following description of the invention which refers to the accompanying drawings which show a preferred embodiment of the present invention.

### BRIEF DESCRIPTION OF THE DRAWINGS

FIG. 1 is a perspective view of an audio supply apparatus in the form of a clock radio with a MP3 player installed in a receptacle of the clock radio;

FIG. 2 is a fragmentary, elevational, cross-sectional and internal view of the clock radio showing a first size and shape MP3 player disposed on a cradle in a receptacle in the player.

FIG. 2A is an enlarged view of FIG. 2 with the MP3 player out of the receptacle.

FIG. 3 is a perspective view showing a second size and shape MP3 player.

FIG. 4 is the same type of view as in FIG. 2 showing a second shapen MP3 player installed.

FIG. 5 is the same type of view as in FIG. 2 showing a third shapen MP3 player installed.

FIG. 6 is a partially internal rear view of a clock radio adapted to receive a MP3 player.

FIG. 7 is a partially internal top view of the clock radio showing the area of the receptacle for the MP3 player.

FIGS. 8 and 9 are top views of two different receptacle adapters for two different size and shape MP3 players to be installed in the clock radio.

### DESCRIPTION OF PREFERRED EMBODIMENT

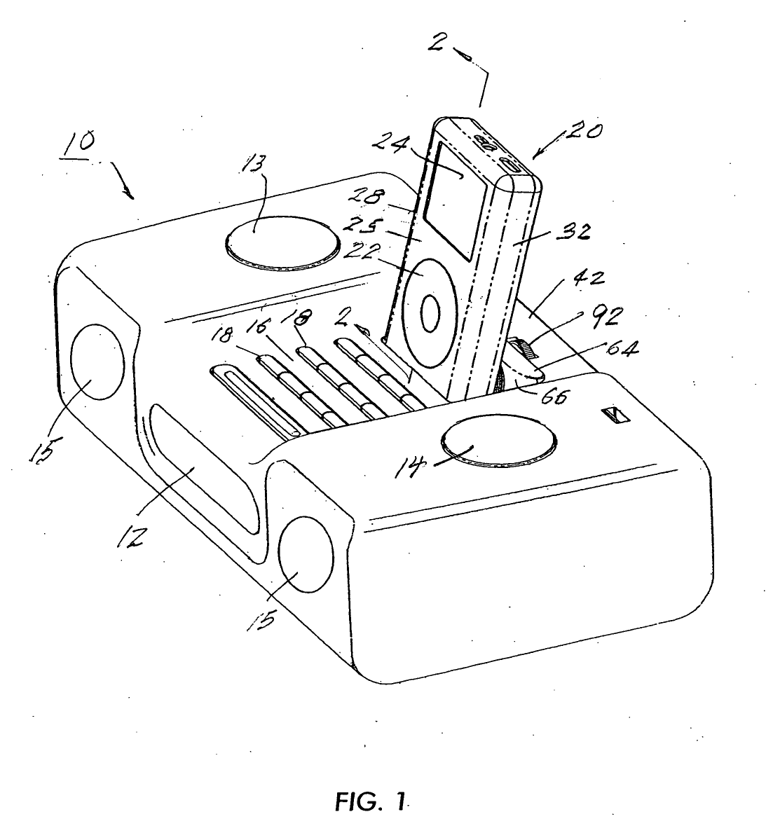

FIG. 1 shows an audio supply apparatus in the form of a clock radio 10 with conventional features including a digital clock face 12, various clock radio controls 13 and 14 speaker boxes 15 at the lateral sides and a control region 16 with various controls 18 thereon for certain features of the clock radio, such as an alarm, time setting, controls for the radio, and possibly controls for an audio supply source, such as a MP3 player, that is to be installed. The clock radio 10 is particularly adapted to receive and use a MP3 player 20 as a source of an audio signal that would be played through the speakers 15 of the clock radio.

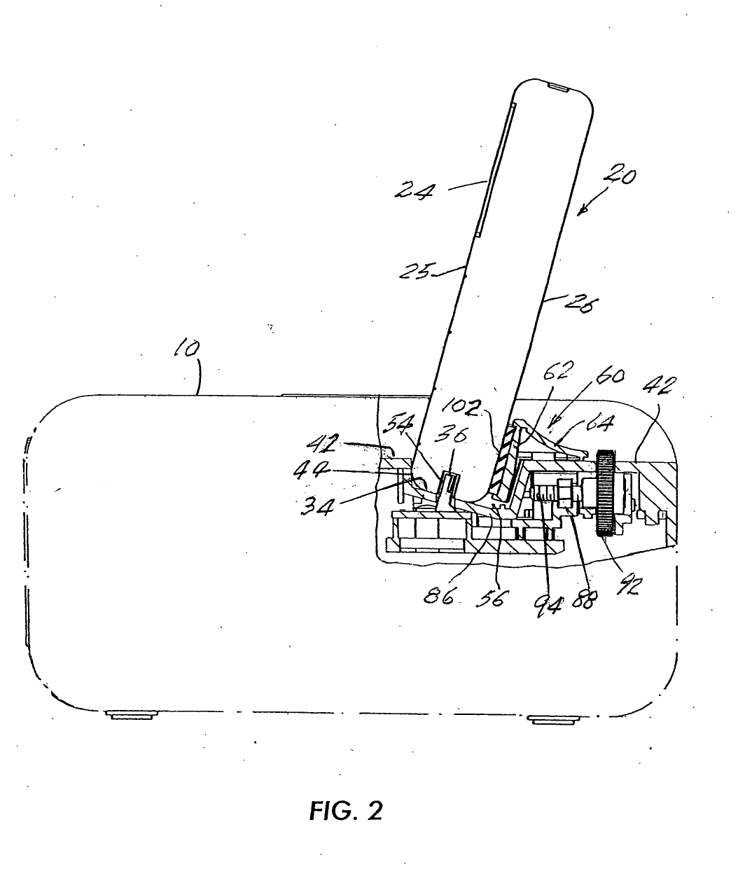

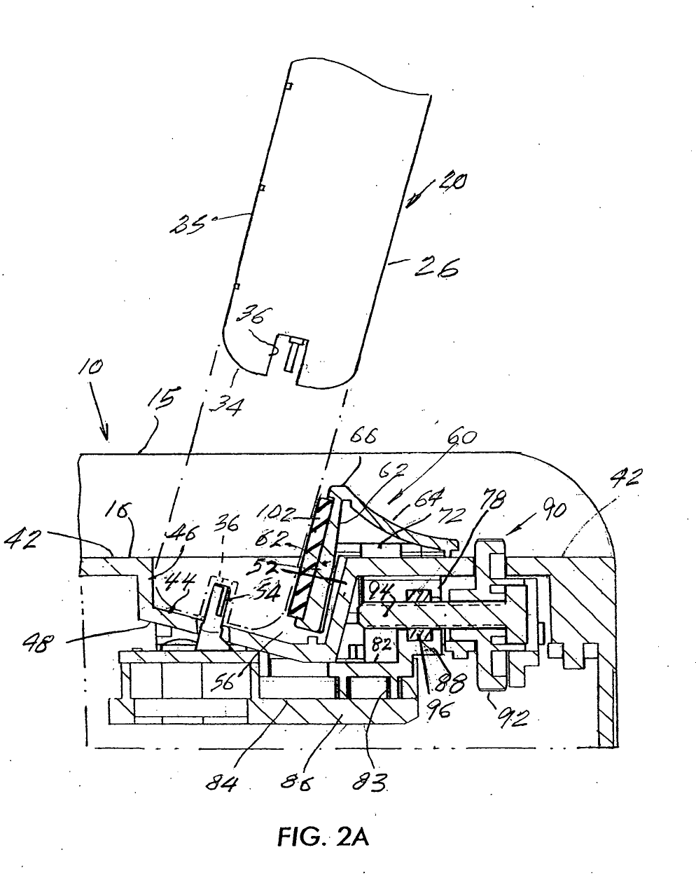

The MP3 player 20 illustrated is of a type sold under the trademark iPod® but may be any MP3 player or other audio signal source capable of supplying an electric signal to the clock radio, which signal is transduceable into an audio signal. The illustrated MP3 player has indicators and control regions 22, 24 on its front side above its lower region which are desirably exposed to view when the MP3 player 20 is installed the below described receptacle in the clock radio. This requirement determines the depth of a receptacle having a cradle therein for the MP3 player. The MP3 player has a thickness between the front side 25 and rear side 26 thereof and has a width between the lateral sides 28 and 32 thereof. The cross section of FIGS. 2 and 2A is located to pass through the bottom side 34 of the MP3 player and it's a connector pin receptacle 36 which is adapted to receive a 32-pin connector from the cradle 44 described below. By that connection, an electrical signal is transmitted from the MP3 player, control signals may be supplied to the MP3 player and an external power supply may be connected to the MP3 player.

The laterally central region 16 of the body of the clock radio 10 is depressed in height as compared with the side speaker boxes 15 which are taller, and that provides additional protection against contact with the controls 18 and also with the MP3 player when it is installed in the receptacle in the body of the clock radio. The central region 16 has a top surface 42, in which there is a recess 44 or a cradle which defines a receptacle into which the MP3 player is installed. The front and rear sides and bottom of that recess are illustrated as being defined by integral parts of the depressed top surface 42, although they may be separate parts attached in the body of the clock radio. The recess defines a cradle 44 having a front wall 46, which merges into a bottom wall 48 that extends rearwardly and is inclined downwardly, and which in turn merges into a rear wall 52 that inclines rearwardly as it extends upwardly. The front to back thickness of the recess or cradle 44 is large enough to accommodate any expected thickness MP3 player.

A conventional 32-pin connector 54 projects up through the bottom wall 48 of the cradle and into the 32-pin connector receptacle 36 of the MP3 player. The locations of the 32-pin connector 54 and connection receptacle 36 will define the front to rear position of the MP3 player in the cradle.

As noted, the cradle 44 is thick enough front to back to receive any thickness of a conventionally available MP3 player. Consequently, some adjustment is needed in the cradle for supporting different thickness MP3 players and the invention provides that.

The body of the MP3 player 20 shown in FIGS. 2 and 2A has the maximum thickness that the front wall 46 of the cradle 44 can accept. With the MP3 player oriented in the cradle 44 by the pin connector 54 extending into the receptacle 36 in the MP3 player, the front side 25 of the MP3 player rests against the front wall 46 of the recess 44. There is a gap space 56 behind the rear side 26 of the MP3 player and the rear wall 52 of the cradle. To support the MP3 player in the recess, it is desirable to provide a gap fill device between the back side 26 of the player and the rear wall 52 of the cradle.

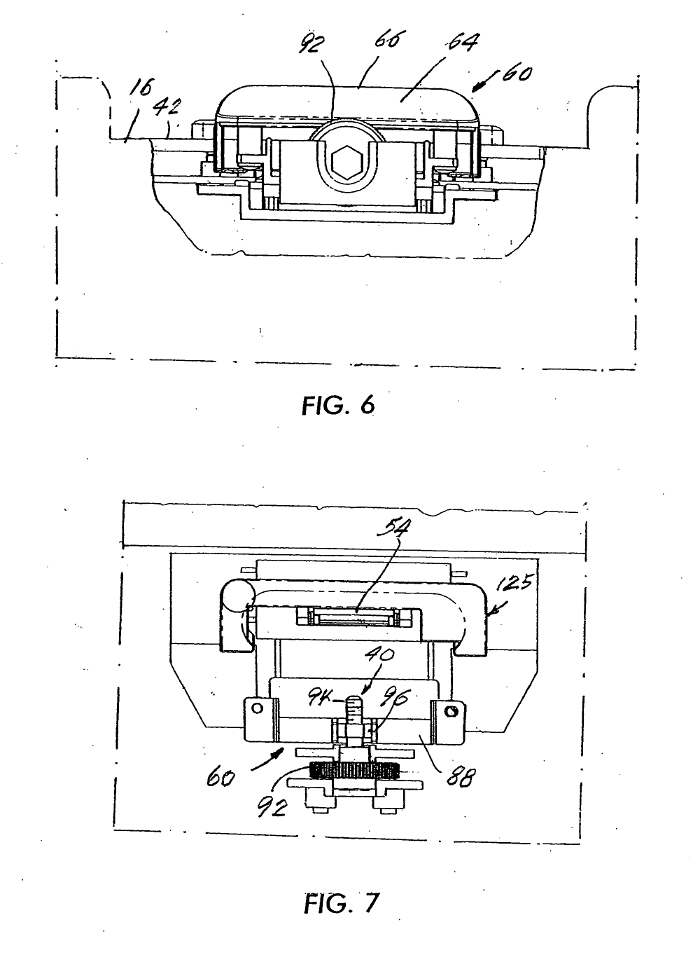

A gap fill device according to the invention for filling the gap 56 between the rear of the MP3 player and the rear wall 52 of the cradle comprises a slide 60 which is supported in the cradle and is supported for forward and rearward sliding motion on the top surface 42 in the depressed central region 16 of the clock radio. As shown in FIGS. 2, 2A, 6, and 7, the slide 60 includes a support plate 62 which extends into the recess 44 and serves to partially fill the gap 56. The top edge of the plate 62 meets the top edge of a guide panel 64, and the plate 62 and panel 64 are integrated at the junction at their apex 66. Thus the entire slide 60 moves together as a single unit. The edge of the panel 64 is supported and guided to slide forward and rearward in a slide guide 72 on the top surface 42 of the housing.

An operator control device moves the slide forwardly and rearwardly. In the illustrated preferred embodiment, the slide includes a guide base 82 with support legs 83 that ride on a shelf surface 84 of a fixed support piece 86 fixed within the housing of the clock radio apparatus and the support legs 83 of the slide forwardly and rearwardly. The shelf surface 84 cooperates with the top surface 42 of the clock radio and the guide panel 64 riding on the surface 42 to provide a straight forward and rearward movement and firm support for the slide without the slide shifting its orientation as it moves forward and rearward.

The slide panel 64 further includes a cross connection plate 88 that extends between the lateral sides of the slide panel. It also includes lateral side panels 89 from the guide panel 64 and downward to the guide base 82.

To move the slide forwardly and rearwardly, the preferred embodiment includes a screw 90 including a thumb screw head 92 with a screw threaded shank 94 that is received in a threaded nut 96 that is fixedly installed in the cross panel 88. Rotation of the screw 90 and its shank 94, through the screw thread connection, moves the panel 88 forwardly and rearwardly and that in turn moves the entire slide 60 forwardly and rearwardly. Appropriate support fixtures supported in the housing of the clock radio hold the thumb screw in a fixed location while enabling its rotation.

On the front side of the plate 62 there may be a resilient, e.g., rubber, pad 102, which combines with the slide plate 62 to fill the gap 56 between the rear side 26 of the MP3 player and the front side of the plate 62 and provides a yieldable, yet removal resisting support surface for the MP3 player. To provide the secure nest for the MP3 player and to ease its installation, and particularly the insertion of the pin connector 54 into the receptacle 36, when the MP3 player initially is installed in the recess 44, the user adjusts the thumb screw 92 to adjust the slide 60 so that the pad 102 on the plate 62 rests lightly against the rear side 26 of the installed MP3 player. Subsequent removal and reinsertion of the MP3 player is lightly resisted by the pad 102, but is not prevented. This prevents the MP3 player from falling out or being jarred loose from its position in the receptacle. It also provides an insertion path that eases insertion of the MP3 player into the receptacle.

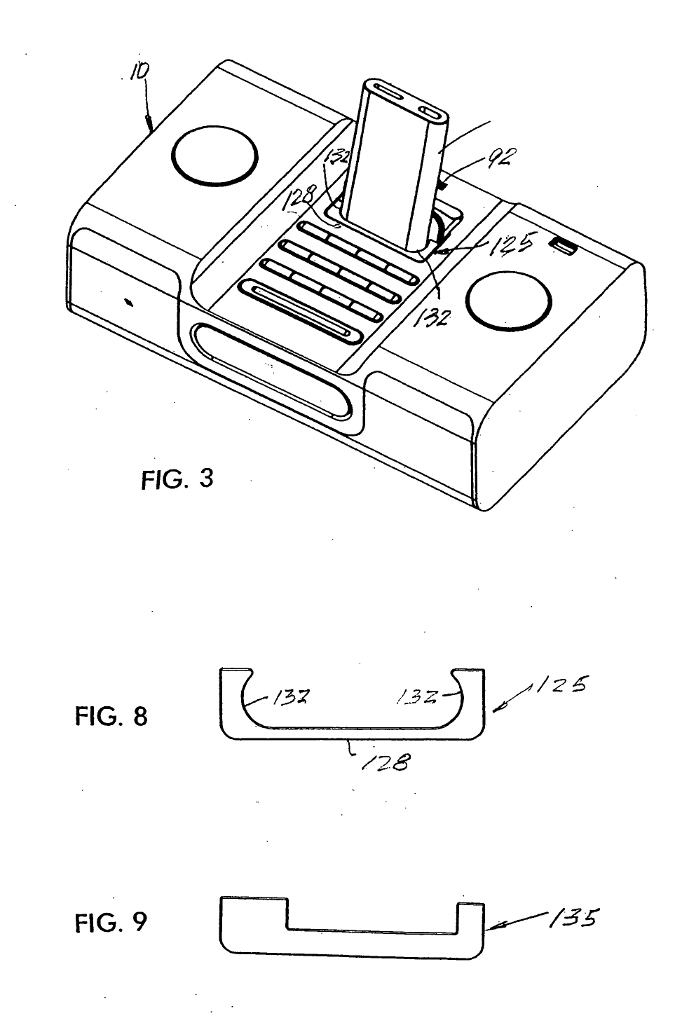

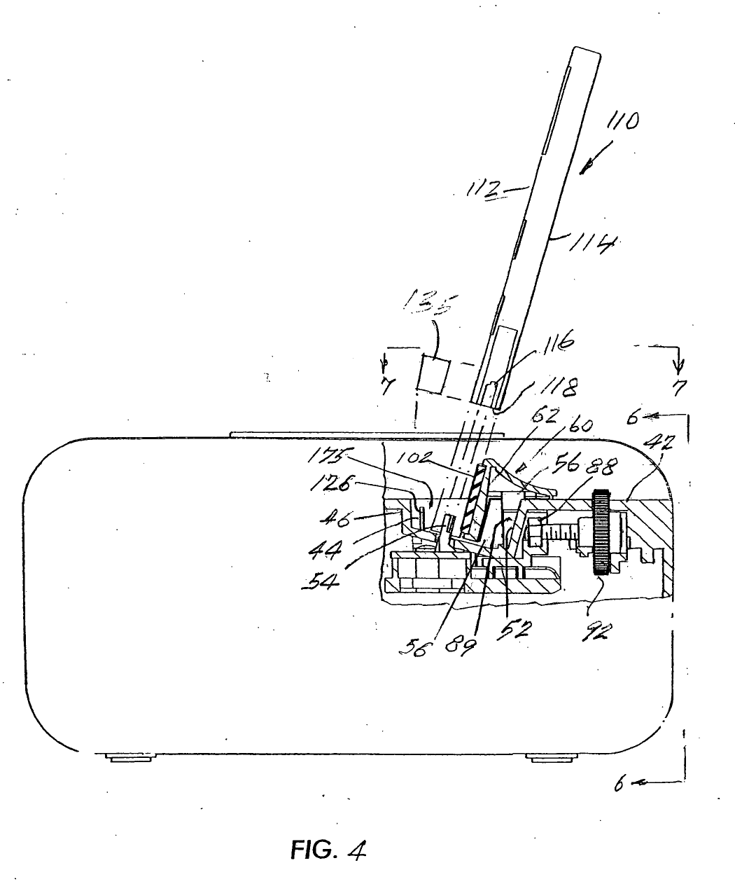

The same apparatus 44, et al. is adaptable for supporting the different front to back thickness MP3 player 110 of FIG. 4 in the same recess 44 in the same clock radio 10 as the first MP3 player embodiment 20. However, some adjustments are made to accommodate the smaller thickness of the MP3 player 110. Since the player 110 is thinner between its front and rear sides 112 and 114, when the player 110 is installed with the 32-pin connector 54 of the cradle in the pin receptacle 116 at the bottom side 118 of the player 110, the gap 56 between the front of the rear wall 52 of the cradle and the rear side of the plate 62 of the slide is larger when the slide 60 is moved forwardly sufficiently that the pad 102 will support the rear surface 114 of the MP3 player. The thumb screw 92 is operated to move the slide 60 forwardly to support the rear side of the MP3 player on the plate 62, 102.

Unlike the first mentioned thicker embodiment the MP3 player 20, the front side of the thinner MP3 player 110 is also not supported by the front wall 46 of the cradle. There is a gap 126 between the front side 112 of the MP3 player and the front wall 46 of the cradle. Various mechanisms for providing support for the front side 112 may be provided, including an equivalent front adjustable slide like the slide 60. But in the present embodiment, it is contemplated to fill that gap 126 with an insert piece tailored to the particular MP3 player. With reference to FIGS. 8 and 9, two proposed insert pieces are illustrated in top view. The first such piece 125 of FIG. 8 is adapted to the thinner MP3 player 110, fits into the gap 126 in front of the front side 112 of the MP3 player and behind the front wall 46 of the cradle and provides a movement resisting filler for the gap 126. The thickness dimension of the front web 128 of the adapter 125 is selected so that with the particular MP3 player 110 installed, the gap 126 will be filled. As seen in FIG. 8, the adapter 125 has profiled sides 132 which are shaped to match the lateral side profile of the MP3 player, and therefore they hold the MP3 player against lateral motion. The adapter positions the player 110 as it is being installed so that the pin connector 54 enters into a receptacle 116 of the MP3 player.

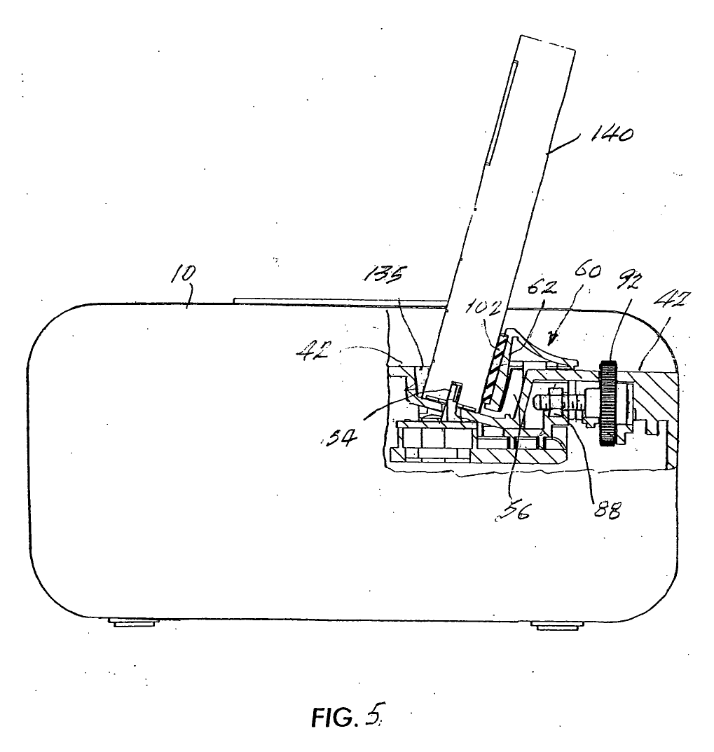

An alternate design adapter 135 is illustrated in FIG. 9. Its features are of the same type as for the adapter 125, but its front to back thickness and shape of its lateral sides are tailored to the different shape and thickness MP3 player 140 shown in FIG. 5.

With the above described apparatus, the MP3 player 20, 110, 140 or one of any other standard shape and size players may be received in the clock radio 10 or other audio supply apparatus, be supported there, be easy to install and be held against vibration jarring and falling out, all with more ease than conventional audio supply apparatus that hold MP3 players.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. Apparatus providing a receptacle for supporting and connecting to a MP3 player, the apparatus comprising:
a body, a recess in the body for defining a receptacle for a MP3 player;
a cradle in the recess for supporting the MP3 player, the cradle having a front wall, a bottom supporting wall and a rear wall, the front and rear walls being spaced apart for receiving any of various front to rear thickness MP3 players;
the front and rear walls of the cradle being spaced apart such that for any thickness MP3 player installed at a selected location front to rear on the cradle, there is a gap space between the rear of the installed MP3 player and the rear wall of the cradle;
a gap fill device disposed in the gap between the rear of the MP3 player and the rear wall of the cradle; and
an operator control connected with the gap fill device for moving the gap fill device in the gap so that the gap fill device contacts the rear of the MP3 player and positions the MP3 player at the selected location.

2. The apparatus of claim 1, further comprising an electrical connector in the receptacle and connected to the MP3 player, and a sound producing system which is connected to the electrical connector so that audio content from the MP3 player may be played through the sound producing system.

3. The apparatus of claim 1, further comprising a connector for the MP3 player for connecting the MP3 player to the apparatus when the MP3 player is in the cradle, the connector being at a location such that with the MP3 player connected to the connector, the MP3 player is at the selected location.

4. The apparatus of claim 3, wherein the connector comprises an electrical connector in the receptacle and connected to the MP3 player, and a sound producing system which is connected to the electrical connector so that audio content from the MP3 player may be played through the sound producing system.

5. The apparatus of claim 4, wherein the connector comprises a pin connector at the cradle and a receptacle for the pin connector in an insertion end of the MP3 player.

6. The apparatus of claim 1, wherein the gap fill device comprises:
an adjustable slide supported on the body, the slide including a plate disposed in the gap between the rear of the MP3 player and the rear wall of the cradle; and
the operator control comprises a slide operator connected with the slide and operable for moving the slide forwardly and rearwardly to shift the position of the plate in the gap so that with the MP3 player installed at the selected location, the plate can be moved to engage the rear of the MP3 player and to support the pager it in the selected position.

7. The apparatus of claim 6, further comprising a support for the slide on the apparatus, whereby the slide is guided for sliding movement by the support thereof on the apparatus.

8. The apparatus of claim 7, wherein the slide operator comprises a rotatable screw supported stationary front to rear in the body and a threaded connection of the screw to the slide so that rotation of the screw moves the slide forwardly and rearwardly.

9. The apparatus of claim 6, further comprising a removable, shaped adapter installable in the cradle at the front wall of the cradle, the adapter having a rear side shaped to the shape of a MP3 player to be installed in the cradle such that with the MP3 player installed in the cradle, the front of the MP3 player contacts the rear side of the inserted adapter and is held there by the plate at the rear of the MP3 player.

10. The apparatus of claim 9, wherein the adapter has a profile on the rear side thereof generally corresponding to the profile of the MP3 player to be installed and so shaped as to position the MP3 player laterally side to side as well as front to rear in cooperation with the gap fill device.

11. Apparatus providing a receptacle for supporting and connecting to a MP3 player, the apparatus comprising:
a body, a recess in the body for defining a receptacle for a MP3 player;
a cradle in the recess for supporting the MP3 player, the cradle having a front wall, a bottom supporting wall and a rear wall, the front and rear walls being spaced apart for receiving any of various front to rear thickness MP3 players;
the front and rear walls of the cradle being spaced apart such that for any thickness MP3 player installed at a selected location front to rear on the cradle, there is a gap space between one wall of the cradle and the opposing side of the MP3 player;
a gap fill device disposed in the gap space;
an operator control connected with the gap fill device for moving the gap fill device in the gap so that the gap fill device contacts the opposing side of the MP3 player, and positions the MP3 player at the selected location.

12. The apparatus of claim 11, comprising:
a connector for the MP3 player for connecting the MP3 player to the apparatus when the MP3 player is in the cradle, the connector being at a location such that with the MP3 player connected to the connector, the MP3 player is at the selected location; and
the connector comprises an electrical connector in the receptacle and connected to the MP3 player, and a sound producing system which is connected to the electrical connector so that audio content from the MP3 player may be played through the sound producing system.
